(19) United States
(12) Patent Application Publication
(10) Pub. No.: US 2012/0261632 A1
(43) Pub. Date: Oct. 18, 2012

(54) Quick-to-erect modular civil safety barrier

(75) Inventor: Vincent BERTUCAT, MONT SAINT AIGNAN (FR)

(73) Assignee: JULIEN CONCEPTION, ROUEN (FR)

(21) Appl. No.: 13/441,346

(22) Filed: Apr. 6, 2012

(30) Foreign Application Priority Data
Apr. 15, 2011 (FR) 1153292

(51) Int. Cl. E04H 17/16; B05D 3/12

(52) U.S. Cl. 256/26; 427/290

(57) ABSTRACT

A civil safety barrier (10) including individual elements (12, 13, 14, 15) intended to be arranged horizontally one after the other, each of which includes at least one link (12A, 12B, 13A, 13B, 14A, 14B, 15A, 15B) made up vertically of a bottom frame and of a top frame (22), characterized in that at least one axial hinge element (32) that is the to be “dismantlable” is interposed between two adjacent edges of the frames which allows the second frame (22) to be fitted perpendicularly to the first (18) and then the second frame (22) to be pivoted to bring it back coplanar with the first.

The invention relates to a quick-to-erect modular civil safety barrier.

The invention relates more particularly to a civil safety and/or protective barrier comprising individual vertical barrier elements intended to be arranged horizontally one after the other, to form a barrier, each of which comprises at least one assembly of two vertically superposed frames known as “links”, which comprises:
a bottom frame of substantially rectangular shape accepting a filling means, notably a grating or set of bars,
a top frame, of substantially rectangular shape, accepting a flat filling means, notably a grating or set of bars, and a bottom edge of which can be accepted removably and immobilized on a top edge of the bottom frame so that the vertically coupled bottom and top frames constitute at least one link of a high barrier.

Numerous examples of civil barriers of this type are known.

Such a barrier can be assembled simply by coupling at least one top frame to one bottom frame in order to enjoy the benefit of a barrier which, on the one hand, occupies a compact position when disassembled and on the other hand offers a tall height when assembled.

However, assembling such a barrier is generally not a very easy task. Two frames are generally assembled using a guideway means, parallel to the upright of the frames, which is interposed between the frames, this guideway means generally being embodied by tubes introduced into sheaths similar to those used in the field of scaffolding in the construction industry. Assembly may also be performed, just as awkwardly, using bolted assemblies or with the aid of latches.

When a top frame is being assembled with a bottom frame using a guideway means, that assumes that the top frame has been brought beforehand up to its assembly height above the bottom frame so that the guideway means can be aligned, then slid horizontally to assemble it with the bottom frame.

When two adjacent frames are being assembled, that assumes that one frame has already been brought up beside and a determined height above the other frame so that the guideway means can be aligned, before lowering it vertically level with the other.

In both instances, this handling operation is considerably awkward because the operators are supporting the load of the top frame at arm's length above the bottom frame.

The invention addresses this disadvantage by proposing a civil safety barrier that can be assembled without any need to lift one frame above the other and using a dismantlable hinge means.

To this end, the invention proposes a civil barrier of the type described hereinabove, characterized in that at least one axial hinge means that is said to be “dismantlable” is interposed between at least one edge of a first frame and the edge of a second frame, and in that it comprises a cylindrical tubular female hinge hook fixed to the edge of the first frame and a complementary hinge pintel, fixed to an edge of the second frame, which comprises a male hinge pin intended to be accepted into the hinge hook, and in that:
the hinge hook comprises a lateral slit the edges of which are parallel to the plane of the first frame,
the hinge pin has a cross section perpendicular to the plane of the second frame the thickness of which corresponds substantially to the width of the slit and the width of which is greater than the width of the slit and less than the diameter of the hinge hook, the said hinge pin being intended:
   when the second frame is arranged perpendicular to the first, to be introduced into the slit of the tubular hinge hook so as to allow the hinge pin to be introduced in a direction perpendicular to the edge of the first frame, and then
   when the second frame has been pivoted to bring it back coplanar with the first, to be pivoted in the slit tubular hinge hook, thereby connecting the first and second frames.

According to other features of the invention:
the slit is centred on the axis of the hinge hook of tubular cross section and the hinge pin is shaped as a plate perpendicular to the plane of the second frame, of a thickness corresponding to the width of the slit and of a width substantially equal to the diameter of the hinge hook,
the slit is centred on the axis of the hinge hook of tubular cross section and the hinge pin has a cross section in the shape is of a crescent perpendicular to the plane of the second frame, having one wall of a curvature the same as that of the slit tubular hinge hook and of total thickness corresponding to the width of the slit,
the slit is excentric with respect to the axis of the hinge hook, one edge of the slit being centred on the axis of the hinge hook and the other edge being tangential to the hinge hook, the hinge pin has a cross section in the shape of half a disc with a curvature and diameter that are the same as those of the hinge hook, and a quarter of the hinge hook adjacent to the slit is blocked off to provide an angular end stop for the rotational movement of the hinge pin,
the edges of the slit are extended by two guide plates parallel to the plane of the first frame, the ends of which are bent away from one another to make it easier to introduce the hinge pin,
the tubular hinge hook is open at its ends and a first end of the hinge pin is connected to the edge of the second frame via at least one blade, parallel to the plane of the second frame and arranged perpendicularly between the edge of the second frame and the hinge pin, of a thickness smaller than the separation between the edges of the slit, and which is intended to slide in the slit to allow the hinge pin to be introduced such that it is coaxial with the tubular hinge hook,
at least one stop means is interposed between the hinge pin and the tubular hinge hook to prevent the hinge pin from coming out if one frame is moved along the other,
the stop means comprises a plate, perpendicular to the plane of the second frame and arranged perpendicularly between the edge of the second frame and a second end of the hinge pin, of a width greater than the separation between the edges of the slit, which is intended to come into abutment against the free end of the tubular hinge hook to immobilize the hinge pin axially with respect to the hinge hook,
the first opposite end of the hinge pin is shaped into a point to make it easier to introduce it into the hinge hook,
each individual element comprises a single link comprising a bottom frame the bottom edge of which has a removable retractable stand at each of its ends,
each individual element comprises at least two vertically superposed links, and a bottom link comprises a bottom frame the bottom edge of which comprises a removable retractable stand at each of its ends,
the first and second frames are bottom and top frames of one and the same link of one and the same individual element, and the dismantlable axial hinge means is interposed between horizontal edges of the first and second frames,
at least one locking means for locking the first and second frames in a coplanar vertical position is interposed between the said first and second frames,
the first and second frames have the same dimensions and comprise tubular vertical edges which are aligned when the frames are in the coplanar vertical position, and the locking means comprises at least one lock bolt which is slidably mounted in one of the vertical edges of one frame and which is able to move between a retracted position in which it is housed in its entirety in the tubular vertical edge of the frame that bears it, and an extended position, in which it can be locked, and in which part of the lock bolt protrudes from the tubular edge of the frame that bears it and is housed in the vertical edge of the other frame in order to prevent the second frame from pivoting on the first frame,
the tubular edge of the frame slidably housing the lock bolt comprises an oblong slot, oriented in the direction of the tubular edge and in which may slide the shank of a screw of which the end is housed in a captive nut secured to the lock bolt and of which a head, shaped as a knob, is intended to be tightened onto the tubular edge in order to immobilize the lock bolt in the edge that bears it,
the first and second frames are bottom and/or top frames of two horizontally consecutive individual elements, and the dismantlable axial hinge means is interposed between bottom and/or top vertical edges of the first and second frames of two consecutive individual elements,
each frame is capable at each of the ends of its bottom edge of accepting a removable retractable stand intended to allow it to be used as a bottom frame, the said stand being able to move between at least one extended position in which it extends perpendicular to the bottom frame and a retracted position in which it lies such that it is coplanar with the frame,
each retractable stand comprises a bar which is fixed transversely at the end of a tube mounted such that it can turn in the tubular vertical edge of the associated frame, the said bar being vertically immobilized between its extended or retracted end positions or extracted with the tube from the tubular vertical edge by means of a bayonet fitting which comprises:
   a disc fixed to the bottom end of the tubular vertical edge and which comprises a radial slit,
   a bracket, of a width smaller than that of the radial slit of the disc, which is fixed to the bar and one leg of which extends above a top face of the disc,
   at least two vertical stops protruding above the top face of the disc in order to determine the two angular rotation positions associated with the extended and retracted positions of the stand, at least one of the stops being removable to allow the bracket to align itself with the slit and to then allow the bar and the tube to be extracted vertically,
at least one stop consists of the head of a screw the screw thread of which is housed in the disc,
each link accepts a connecting means having at least one brace supporting each individual element,
the brace comprises an inclined tube element a top end of which is connected to the top edge of a top frame of a link, at least an intermediate part of which is connected by a horizontal bar to the junctions between the bottom/top frames of the said link, and a bottom end of which slidably accepts a bar connected to a baseplate for resting on the ground, which baseplate is articulated to the said bar by a pivot,
the top end of the brace comprises a horizontal tab intended to straddle the top end of the vertical edge of the top frame of the link to form the connecting means,
one end of each horizontal bar connected to each intermediate part comprises a holed tab through which the corresponding lock bolt is intended to pass where the bottom and top frames of a link meet in order to form the connecting means,
each frame accepts a grating or alternatively a set of bars to form the means that fills the said frame.

The invention also relates to a method of manufacturing a frame of an individual safety barrier element, comprising at least one top horizontal tubular edge and one bottom horizontal edge between which edges a set of bars extends, characterized in that it comprises:
a first step during which first vertical drillings are made in a bottom wall of the top tubular edge of the frame,
a second step during which second vertical drillings are made only in a top wall of the bottom tubular edge of the frame, in line with the first drillings, and offset third vertical drillings are made in a bottom wall of the bottom tubular edge of the frame,
a third step during which a grating or a set of bars of a length substantially corresponding to the vertical distance separating the end faces of the top and bottom edges and the bottom end of which is chamfered at 45 degrees is slipped into the first and second drillings as far as a position of abutment determined by a non-drilled bottom wall of the bottom edge,
a fourth step during which the bottom and top edges of the frame and possibly, at discrete points, the grating or the set of bars are connected to an electric arc welding device,
ba fifth step during which the frame is immersed in a hot dip galvanizing bath which completes the attachment of all the bars in a single operation, the molten zinc later flowing through the third drillings.

Other features and advantages of the invention will become apparent from reading the detailed description which follows, for an understanding of which reference will be made to the attached drawings in which:

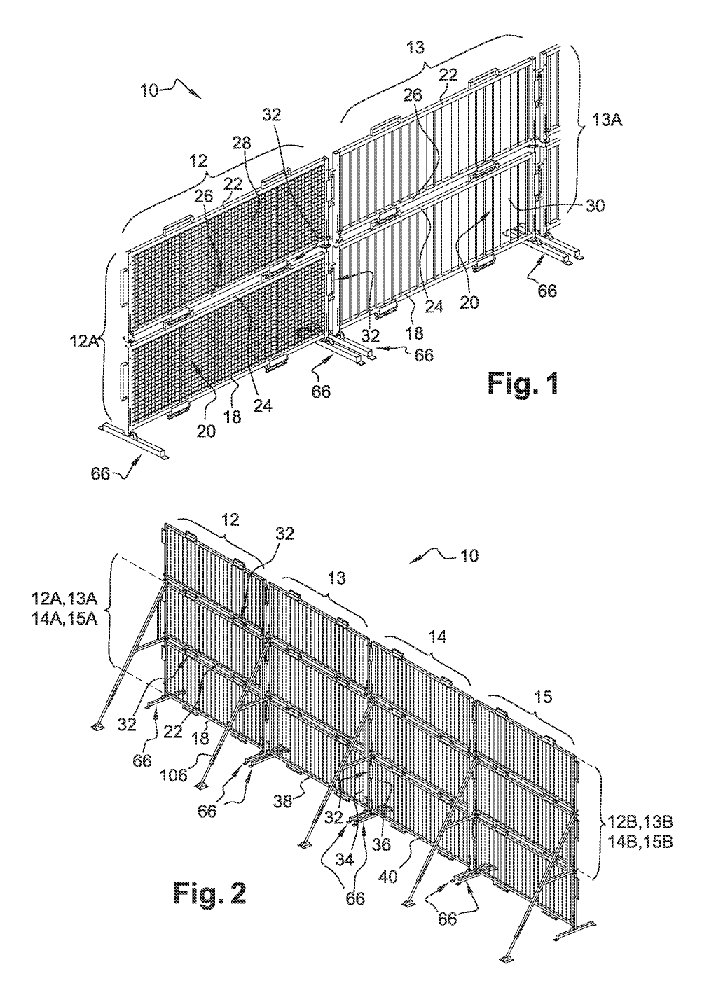

FIG. 1 is a perspective view of a barrier according to a first embodiment of the invention;

FIG. 2 is a perspective view of a barrier according to a second embodiment of the invention;

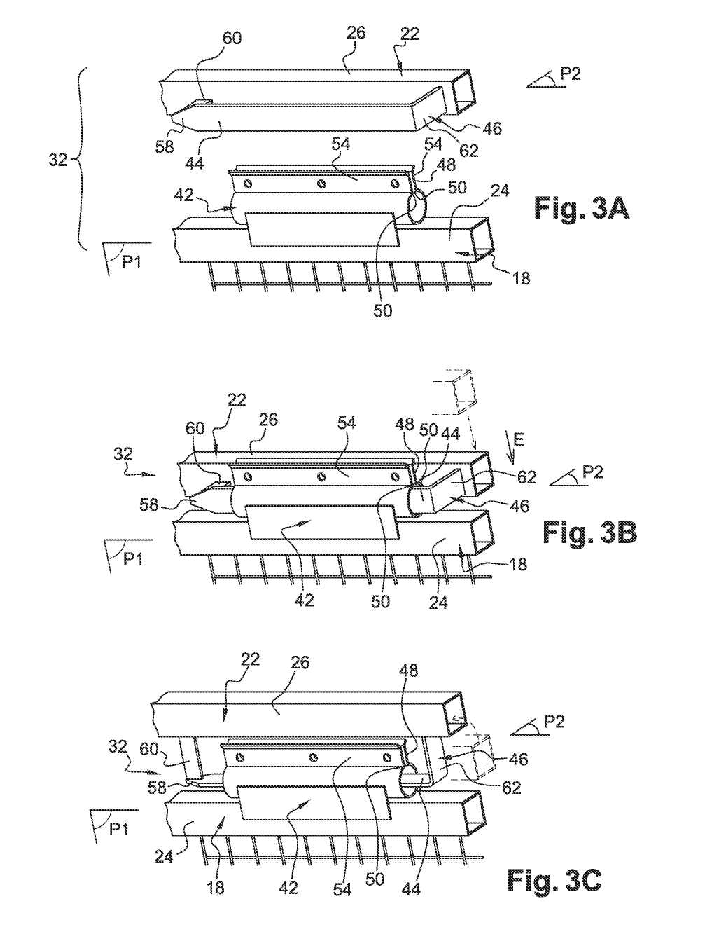

FIGS. 3A to 3C are detailed perspective views illustrating a first method of insertion of a dismantlable hinge means;

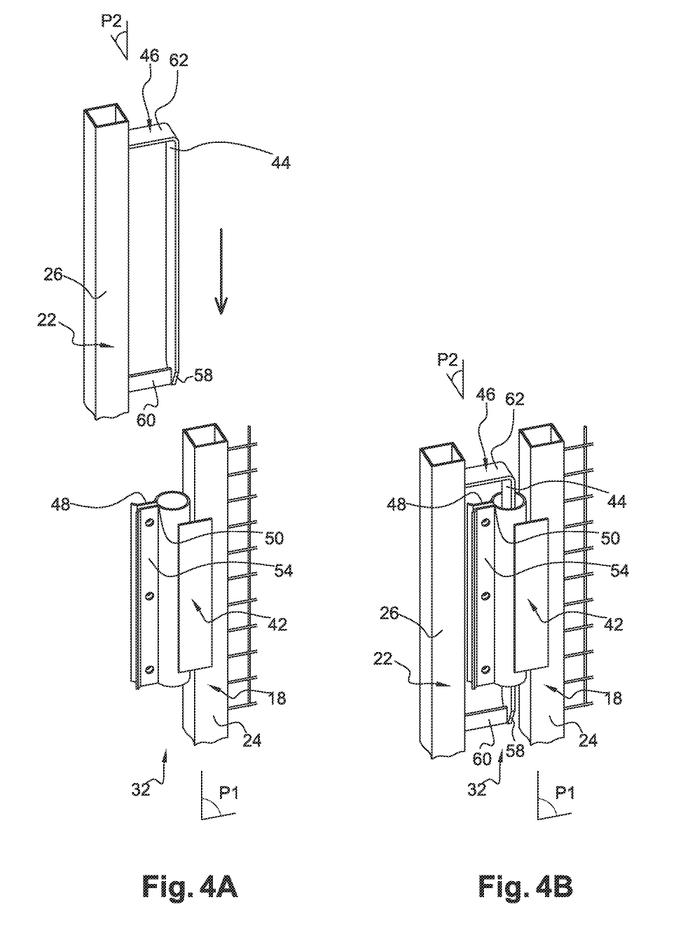

FIGS. 4A and 4B are detailed perspective views illustrating a second method of insertion of a dismantlable hinge means;

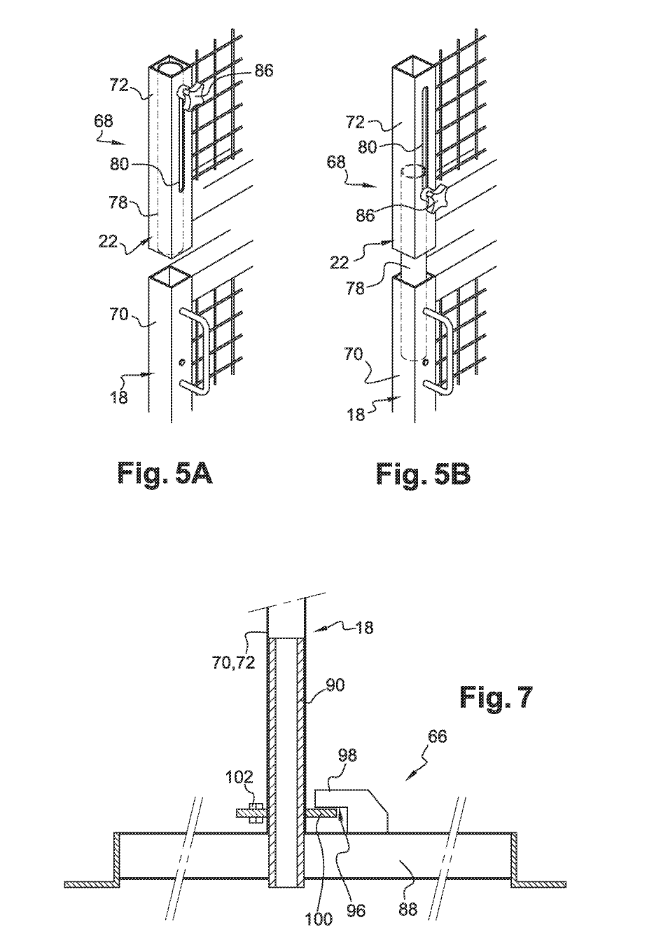

FIGS. 5A and 5B are detailed perspective views illustrating the extreme positions of the locking means that locks two frames in a coplanar vertical position;

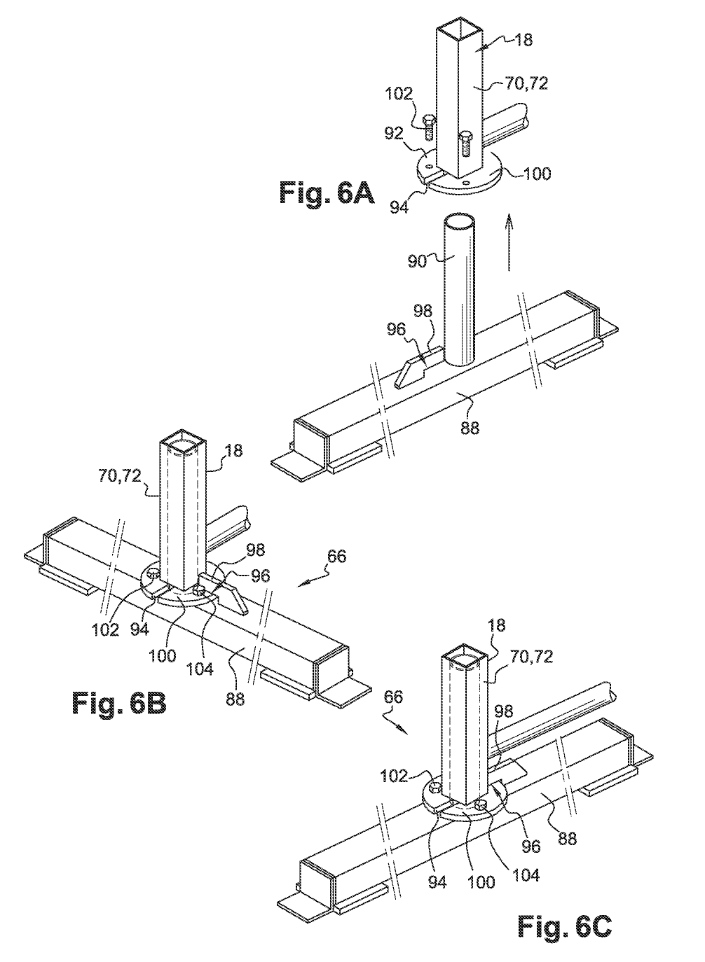

FIGS. 6A to 6C are detailed perspective views depicting a stand in its extreme extracted, retracted or extended positions;

FIG. 7 is a view in cross section of a stand;

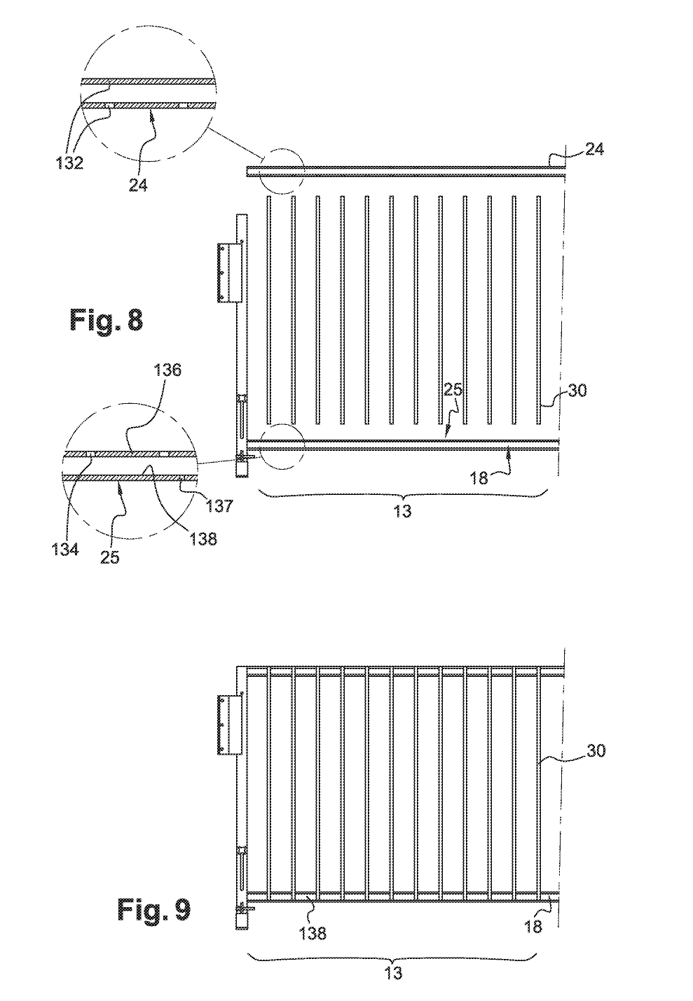

FIGS. 8 and 9 are views in cross section illustrating the steps in the manufacture of a frame comprising sets of bars;

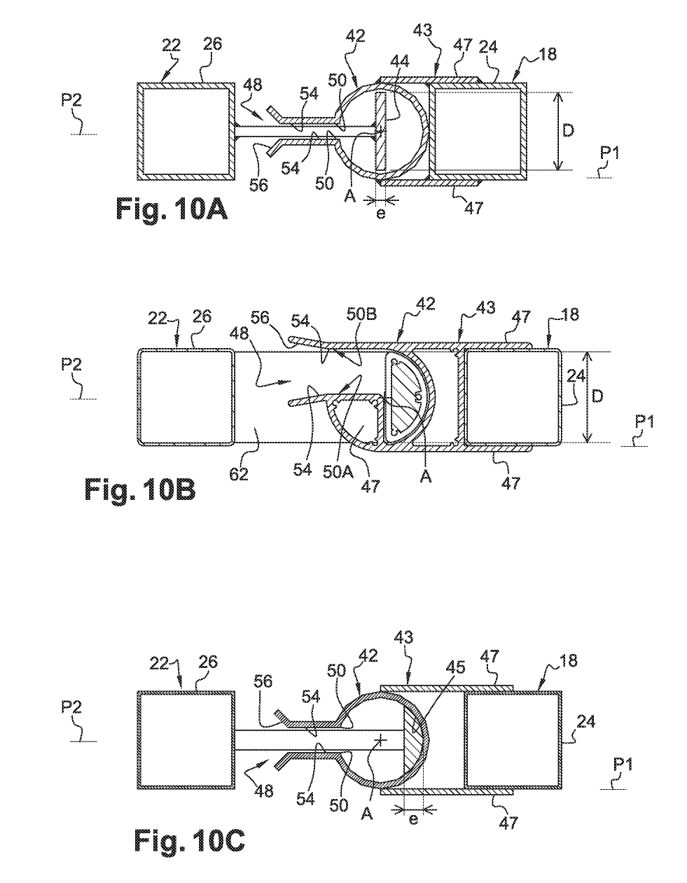

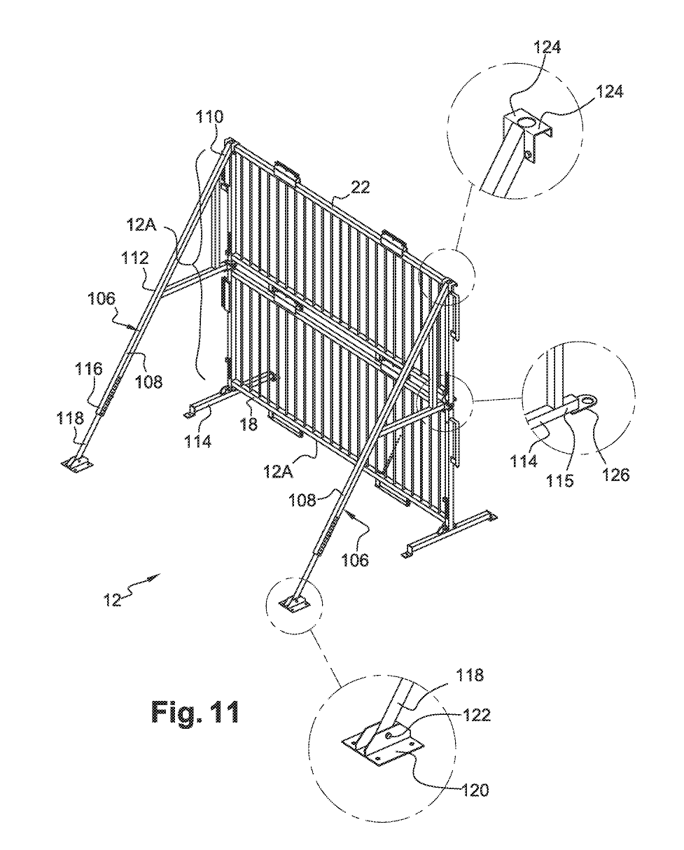

FIGS. 10A to 10C are views in cross section illustrating three embodiments of the hinge according to the invention;

FIG. 11 is a perspective view illustrating the barrier being held up using braces.

In the description which follows, identical reference numerals denote parts which are identical or have similar functions.

FIGS. 1 and 2 depict a civil safety and/or protective barrier 10 comprising individual barrier elements 12, 13, 14, 15 intended to be arranged horizontally one after another, each of which comprises at least one assembly of two superposed frames known as a “link”.

Thus, the barrier of FIG. 1 comprises individual elements 12, 13 each comprising just one simple link 12A, 13A, and the barrier of FIG. 2 comprises individual elements 12, 13, 14, 15, 16 each comprising superposed links 12A, 12B, 13A, 13B, 14A, 14B, 15A, 15B.

Thus, each individual element 12, 13 of the barrier of FIG. 1 comprises a single link 12A, 13A comprising a bottom frame the bottom edge of which at each of its ends has a removable retractable stand 66, while each individual element 12, 14, 16 in FIG. 2 comprises at least two vertically superposed links 12A, 12B, 13A, 13B, 14A, 14B, 15A, 15B and a bottom link 12A, 13A, 14A, 15A comprises a bottom frame the bottom edge of which at each of its ends comprises a removable retractable stand 66.

It will therefore also be understood that, for an individual element comprising more than one link as is the case in FIG. 2, at least one top frame of a bottom link 12A, 13A, 14A, 15A is also the bottom frame of the link 12B, 13B, 14B, 15B immediately above it.

It will quite obviously be understood that each individual element could comprise a higher number of links and therefore of frames.

As FIG. 1 illustrates, according to the invention, the frames are interchangeable and each link 12A, 13A comprises vertically:
a bottom frame 18 of substantially rectangular shape accepting a filling means 20, notably a grating or set of bars,
a top frame 22, of substantially rectangular shape, accepting a filling means 20, notably a grating or set of bars, and of which a lower edge 26 can be accepted removably and immobilized on a top edge 24 of the bottom frame 18 so that the vertically coupled bottom 18 and top 22 frames constitute at least one link 12A, 13A of a barrier 10 of great height.

It will be understood, as illustrated by FIGS. 8 to 10, that each frame may accept a filling means 20 consisting of a grating 28 or set of bars 30.

The frames are tubular and can be made of steel or of aluminium alloy.

According to the invention, as illustrated by FIGS. 1 and 2, at least one axial hinge means 32 said to be “dismantlable” is interposed between at least one edge 24, 34 of a first frame 18, 38 and the edge 26, 36 of a second frame 22, 40.

More specifically, it will be understood that the axial hinge means 32 can, as illustrated in FIG. 1, be interposed with equal preference between the horizontal edges 24, 26 of the bottom 18 and top 22 frames of one and the same link 12A of one and the same individual element 12 and/or, as illustrated in FIG. 2, between the vertical edges 34, 36 of the horizontally adjacent frames 38, 40 of two different individual elements 13, 14.

The remainder of the present description will confine itself to the assembly as illustrated in FIG. 2, of one link 12A of an individual element 12, made up of a bottom frame 18 and of a top frame 22, using a hinge means 32, but it must be understood that the principle of assembly that will be described can be read across to the assembling of consecutive frames, notably to the assembling of these consecutive frames 38 and 40 of FIG. 2.

As FIGS. 3A to 4B illustrate, the hinge means 32 comprises a tubular female hinge hook 42 fixed to the edge 24 of the first frame, here the bottom frame 18, and a male hinge pin 44 of a complementary hinge pintel 46 which is fixed to one edge 26 of the second frame, here the top frame 22.

It will be understood that the hinge 32 could, by a simple mechanical reversal of roles, comprise a tubular female hinge hook 42 fixed to the edge 26 of the top frame 22 and a male hinge pin 44 of a complementary hinge pintel 46 fixed to an edge 24 of the bottom frame 18, without that changing the nature of the invention.

According to the invention, the hinge hook 42 comprises a lateral slit 48, the edges 50 of which are parallel to the plane “P1” of the first frame 18, and which is centred on the axis “A” of the hinge hook of cylindrical tubular cross section, as depicted in FIG. 10A.

As FIGS. 3A to 3C and 10A illustrate, the hinge pin 44 is shaped as a plate of thickness “e” perpendicular to the plane “P2” of the second frame 22, corresponding to the width of the slit 48, and of a width substantially equal to the diameter “D” of the slit hinge hook 42.

As FIG. 3A illustrates, when the second frame 22 is arranged perpendicular to the first frame 18, the hinge pin 44 is intended to be introduced into the slit 48 to allow the hinge pin 44 to be introduced in a direction “E” perpendicular to the edge 24 of the first frame 18, as illustrated by FIG. 3B.

Then, as illustrated by FIG. 3C, the second frame 22 is pivoted to bring it back coplanar with the first. As a result of this, the hinge pin 44 pivots in the tubular hinge hook 42, thus allowing it to join the first and second frames 18, 22 together.

It will be appreciated that once connected, the frames can tolerate a very substantial relative angular travel, typically of the order of 120 degrees, without become detached from one another.

It will be appreciated that all the frames are interchangeable and comprise hinge parts on their four edges. This makes the erection of barriers according to the invention easier.

FIGS. 10B and 10C illustrate alternative forms of embodiment of the hinge 32.

According to a second embodiment which has been depicted in FIG. 10C, the slit 48 is centred on the axis “A” of the hinge hook of cylindrical tubular cross section and the hinge pin 44 has a cross section in the shape of a crescent comprising a wall 45 of a curvature the same as that of the hinge hook and of a total thickness “e” corresponding to the width of the slit.

Finally, according to a third embodiment which has been depicted in FIG. 10B, the slit 48 is excentric with respect to the axis of the hinge hook, one edge 50A of the slit being centred on the axis “A” of the hinge hook and the other edge 50B being tangential to the hinge hook. The hinge pin 44 has a cross section the shape of half a disc with a curvature and diameter “D” that are the same as those of the hinge hook. Moreover, a quarter 47 of the hinge hook adjacent to the slit 50 may be closed off as depicted in FIG. 10B to lock the hinge pin 44 angularly in rotation. This configuration does not, however, place any limitation on the invention.

In each of these embodiments, the tubular hinge hook 42 comprises a chassis 43 comprises two parallel flanges 45 intended to grip the upright 18 of the associated frame.

These flanges 45 may be bolted to the upright 18 or welded thereto.

It will be noted that in the embodiments of FIGS. 10A and 10C, the hinge hook 42 is housed in the chassis 43 to which it is, for example, welded, whereas in the embodiment of FIG. 10B, the hinge hook 42 is formed as an integral part of the chassis 43, these different variations obviously not placing any limitation on the invention.

For preference, the edges 50 of the slit 48 are extended by two guide plates 54 parallel to the plane “P1” of the first frame 18. For preference, but without placing any limitation on the invention, the ends 56 of these plates 54 are bent away from one another to make introduction of the hinge pin 44 easier.

Advantageously, holes may be made facing one another in the guide plates, these holes being intended to accept rods or pins intended to prevent the hinge pins 44 from leaving the hinge hooks 42, particularly in the event of great pressure from the crowd.

It will be understood that the lateral slit 48 and its edges 50, and the guide plates 54 could be non-parallel to the plane “P1” of the first frame 18, but inclined by a determined angle, as this would make it possible to limit the angle of introduction of the hinge pin 44 into the hinge hook 42, this being particularly advantageous for vertical connections between frames.

The hinge pin 44 may advantageously be introduced into the hinge hook 42 in a different way, as illustrated by FIGS. 4A and 4B.

For that, the tubular hinge hook 42 is open at its ends and a first end 58 of the hinge pin 44 is connected to the edge 26 of the second frame 22 by at least one blade 60 parallel to the plane of the second frame 22 and arranged perpendicularly between the edge 26 of the second frame 22 and the hinge pin 44, of a thickness less than the separation between the edges 50 of the slit 48, so as to allow the first blade 52 of the hinge pin 44 to be introduced such that it is coaxial with the tubular hinge hook 42.

In that way, as FIGS. 4a and 4B illustrate, the blade 60 slides in the slit 48 without preventing the hinge pin 44 from entering it.

Advantageously, it will be noted that the end 58 of the hinge pin 44 is shaped into a point to make it easier to introduce into the hinge hook 42.

In order to allow the hinge pin 44 to remain in the hinge hook 42, a stop means is interposed between the hinge pin 44 and the tubular hinge hook 42.

For that reason, the stop means comprises a plate 62, perpendicular to the plane “P2” of the second frame 22 and arranged perpendicularly between the edge 26 of the second frame 22 and a second end 64 of the hinge pin 44, of a width greater than the separation between the edges 50 of the slit 48, which is intended to come into abutment against the free end 66 of the tubular hinge hook 42 in order to immobilize the hinge pin 44 axially with respect to the hinge hook 42. This plate 62 prevents the hinge pin 44 from coming out notably when the frames slide along one another.

This configuration also makes it possible to limit the introduction and exit of the hinge pin 44 to just one side of the tubular hinge hook 42.

As an alternative, the hinge pin 44 could comprise neither blade 60 nor pointed end 58, but have two plates 62 at each of its ends. This configuration notably makes it possible to propose a barrier the individual elements of which can be mounted only using the first method of assembly mentioned. Thus, a barrier made up of such individual elements can be dismantled only by successively dismantling its elements. A barrier such as this is particularly well suited to containing heavy crowd movement.

When consecutive horizontal frames are assembled, the plate 62 is arranged a few centimetres from the top end of the tubular hinge hook 42 in order to allow the frames some degree of vertical relative movement on uneven ground.

As was seen earlier in relation to FIG. 2, the first and second frames 18, 22 may be bottom and/or top frames of two horizontally consecutive individual elements 13, 14 and, in this case, the dismantlable axial hinge means 32 is interposed between bottom and/or top vertical edges of the first and second frames of two consecutive individual elements 13, 14.

As FIG. 1 illustrates, the first frame 18 and the second frame 22 may also be bottom and top frames of one and the same link of one and the same individual element and in this case the dismantlable axial hinge means 32 is interposed between horizontal edges 24, 26 of the first and second frames 18, 22.

In this case, as FIGS. 3A and 3B illustrate, the top frame 22 is introduced horizontally onto the first frame 18, then stood up into a vertical position. It is therefore necessary to be able to lock the frames 18, 22 in their vertical position.

To do this, as FIGS. 5A and 5B illustrate, at least one locking means 68 for locking the first and second frames 18 in the coplanar vertical position is interposed between the said first and second frames 18, 22.

In the preferred embodiment of the invention, the first and second frames 18, 22 of one and the same vertical link have the same dimensions and comprise tubular vertical edges 70, 72, which are aligned when the frames 18, 22 are in the coplanar vertical position. As FIGS. 5A and 5B illustrate, the locking means comprises at least one lock bolt 78 which is slidably mounted in one of the vertical edges 70, 72 of one frame 18, here the edge 72, and which is able to move between a retracted position depicted in FIG. 5A, in which it is housed in its entirety in the tubular vertical edge 72 of the frame 18 that bears it, and an extended position depicted in FIG. 5B, in which it can be locked and in which part of the lock bolt 78 protrudes from the tubular edge 72 of the frame that bears it and is housed in the vertical edge 70 of the other frame 22, to prevent the second frame 22 from pivoting on the first frame 18.

More particularly, the tubular edge 72 of the frame 18 slidably housing the lock bolt 78 comprises an oblong slot 80, oriented in the direction of the tubular edge 70,72, and which allows the sliding of the shank (not depicted) of a screw of which the end is housed in a captive nut secured to the lock bolt 78 and of which a head 86, shaped as a knob, is intended to be clamped onto the tubular edge 70, 72 to immobilize the lock bolt 78 in the edge 72 that bears it.

As FIGS. 1 and 6A to 7 illustrate, for interchangeability purposes, each frame 18, 20 can interchangeably accept at each of the ends of its bottom edge a removable retractable stand 66 intended to allow it to be used as a bottom frame.

The stand 66 is able to move between at least one extended position depicted in FIG. 6B in which it extends perpendicular to the bottom frame 18 and a retracted position depicted in FIG. 6C in which it lies coplanar with the frame 18.

More particularly, each retractable stand 66 comprises a bar 88 which is fixed transversely at the end of a tube 90 mounted such that it can turn in the tubular vertical edge 70, 72 of the associated frame 18, the said bar being vertically immobilized between its extended or retracted end positions or extracted with the tube 90 from the tubular vertical edge 70, 72 by means of a bayonet fitting.

It will be understood that the bar 88 is preferably housed in the tube 70, 72 of the frame on the opposide side to the lock bolt 78, in order to avoid any risk of interference between the lock bolt 78 and the tube 90.

As an alternative, it is possible to conceive of a lock bolt that is retractable enough to allow the insertion of the tube 90. Use of the lock bolt is then prevented.

More particularly, the bayonet fitting of each stand 66 comprises:
a disc 92 fixed to the bottom end of the tubular vertical edge 70, 72 and which comprises a radial slit 94,
a bracket 96, of a width smaller than that of the radial slit 94 of the disc 92, which is fixed to the bar 88 and one leg 98 of which extends above a top face 100 of the disc 92,
at least two vertical stops 102 and 104 protruding above the top face 100 of the disc 92 in order to determine the two angular rotation positions associated with the extended and retracted positions of the stand 66, which have been depicted in FIGS. 6B and 6C respectively.

As an alternative (which has not been depicted), the slit made in a complete disc could be replaced by a flat formed in a portion of the disc, the bayonet fitting of each stand 66 then comprising only part of a disc.

Specifically, the vertical stops 102 and 104 secured to the discs are capable of opposing the pivoting movement of the tube 90 once the bracket 96 secured to the tube 90 via the bar 88 comes up against one or other of the vertical stops.

The angular separation of the radii passing through the stops 102 and 104 therefore determines the angular rotational travel of the bar 88. An angular separation of 90 degrees will preferably be chosen.

Advantageously, at least one of the stops 102, 104 can be extracted in order to allow the bracket 96 to align itself with the slit 94 and to then allow the bar 88 of the tube 90 to be extracted vertically.

In the alternative form of embodiment, at least one of the stops 102, 104 can be extracted in order to allow the bracket 96 to align itself with the flat in order to allow the bar 88 and the tube 90 to be extracted vertically.

For example, the stop 102 can be extracted and consists of the head of a screw the thread of which is housed in the disc 92, while the stop 104 is fixed.

The disc could also comprise two opposing stop screws 102, to allow the stand to be mounted with two opposite directions of rotation.

According to one embodiment of the invention that has been depicted in FIG. 2 and which is particularly applicable, although without placing any limitation on the invention, to barriers of great height comprising several vertical links, each link 12A, 12B, 13A, 13B, 14A, 14B, 15A, 15B accepts a means of connection to at least one brace 106 supporting each individual element 12.

More particularly, as illustrated in FIG. 2, the brace 106 comprises an inclined tube element 108 a top end 110 of which is connected to the top edge of a top frame of a link 12A, at least an intermediate part 112 of which is connected by a horizontal bar 114 to the junctions between the bottom 18/top 22 frames of the intermediate link 12A, and a bottom end 116 of which slidably accepts a bar 118 connected to a baseplate 120 for resting on the ground, which baseplate is articulated to the said bar 118 by a pivot 122.

The brace 106 obviously has to be placed on the opposite side of the barrier to the event that is being made safer.

As FIG. 2 illustrates, the top end 110 of the brace 106 comprises a horizontal tab 124 intended to straddle the top end of the vertical edge 22 of the top frame of the link 12A in order to form the connecting means.

Moreover, one end 115 of each horizontal bar 114 connected to the intermediate part 112 comprises a holed tab 126 through which the corresponding lock bolt (not depicted) is intended to pass where the bottom 18 and top 22 frames of a link 12A meet.

It is possible to conceive of equipping the top frames with devices of the spikes type to prevent people climbing over. This may be done for example by introducing sleeves or bolts into the vertical uprights of the top frames and this spikes device can be fitted in the same way regardless of the number of links in the individual element.

The frames can be filled in different ways.

According to a first embodiment of this filling, as illustrated in FIG. 1, each frame 18, 22 of the individual element 12 accepts a grating 28 which is welded to the said frame 18, 22 to form the means of filling.

According to a second embodiment of this filling, as illustrated by the individual element 13 in FIG. 1, the individual elements 12, 13, 14, 15 of FIG. 2, and FIGS. 8 and 9, each frame 18, 22 accepts sets of bars 30 which are welded to the said frame 18, 22 to form the means of filling.

Each frame may advantageously be obtained in a very simple way using a very simple method of manufacture involving:
a first step during which first vertical drillings 132 are made in a bottom wall of the top tubular edge 24 of the frame 18, as depicted in FIG. 8,
a second step during which second vertical drillings 134 are made in a top wall 136 of the bottom tubular edge 25 of the frame 18, in line with the first drillings 132, as depicted in FIG. 8, and offset third vertical drillings 137 are made in a bottom wall 136 of the bottom tubular edge 25 of the frame 18,
a third step during which a grating 28 or a set of bars 30 of a length substantially corresponding to the vertical distance separating the end faces of the top 24 and bottom 25 edges is slipped into the first and second drillings 132, 134 as far as a position of abutment determined by a non-drilled bottom wall 138 of the bottom edge 25, as depicted in FIG. 9,
a fourth step (not depicted) during which the bottom 25 and top 24 edges of the frame are connected up to the terminals of an electric arc welding means and possibly to the grating 28 or to the sets of bars 30,
a fifth step (not depicted) during which the frame is immersed in a hot dip galvanizing bath to complete the attachment of the grating 28 or of all the bars 30 in a single operation, the molten zinc later flowing out through the third drillings 137.

This method therefore notably makes it possible to avoid the need for an operation of welding bar by bar by attaching all the bars of the set 30 in a single pass.

The invention therefore proposes an innovative and modular civil safety barrier 10 that can be assembled rapidly, is robust and secure.

1. Civil safety and/or protective barrier (10) comprising individual barrier elements (12, 13, 14, 15) intended to be arranged horizontally one after the other, each of which comprises at least one assembly of two vertically superposed frames known as “links” (12A, 12B, 13A, 13B, 14A, 14B, 15A, 15B) which comprises:
a bottom frame (18) of substantially rectangular shape accepting a filling means (20), notably a grating (28) or set of bars (30),
a top frame (22), of substantially rectangular shape, accepting a filling means (20), notably a grating (28) or set of bars (30), and a bottom edge (26) of which can be accepted removably and immobilized on a top edge (24) of the bottom frame (18) so that the vertically coupled bottom (18) and top (22) frames constitute at least one link (12A, 13A) of a high barrier,
characterized in that the frames are interchangeable and in that at least one axial hinge means (32) that is said to be “dismantlable” is interposed between at least one edge (24, 34) of a first frame (18, 38) and the edge (26, 36) of a second frame (22, 40), and in that it comprises a cylindrical tubular female hinge hook (42) fixed to the edge (24) of the first frame and a complementary hinge pintel (46), fixed to an edge (26) of the second frame, which comprises a male hinge pin (44) intended to be accepted into the hinge hook (42), and in that:
the hinge hook (42) comprises a lateral slit (48), the edges (50) of which are parallel to the plane (P1) of the first frame,
the hinge pin (44) has a cross section perpendicular to the plane of the second frame, the thickness (e) of which corresponds substantially to the width of the slit (48) and the width of which is greater than the width of the slit and less than the diameter (D) of the hinge hook (42), the said hinge pin (44) being intended:
when the second frame (22) is arranged perpendicular to the first (18), to be introduced into the slit (48) of the tubular hinge hook so as to allow the hinge pin (44) to be introduced in a direction (E) perpendicular to the edge (24) of the first frame (18), and then
when the second frame (22) has been pivoted to bring it back coplanar with the first, to be pivoted in the slit tubular hinge hook (42), thereby connecting the first and second frames (18, 22).

2. Barrier (10) according to claim 1, characterized in that the slit (48) is centred on the axis (A) of the hinge hook (42) of tubular cross section and in that the hinge pin (44) is shaped as a plate perpendicular to the plane (P2) of the second frame (22), of a thickness corresponding to the width (e) of the slit and of a width substantially equal to the diameter (D) of the hinge hook (42).

3. Barrier (10) according to claim 1, characterized in that the slit (48) is centred on the axis (A) of the hinge hook (42) of tubular cross section and in that the hinge pin (44) has a cross section in the shape of a crescent perpendicular to the plane (P2) of the second frame (22), having one wall (45) of a curvature the same as that of the slit tubular hinge hook and of total thickness (e) corresponding to the width of the slit (48).

4. Barrier (10) according to claim 1, characterized in that the slit (48) is excentric with respect to the axis (A) of the hinge hook (42), one edge (50A) of the slit being centred on the axis (A) of the hinge hook (42) and the other edge (50B) being tangential to the hinge hook (42), in that the hinge pin (44) has a cross section in the shape of half a disc with a curvature and diameter (D) that are the same as those of the hinge hook (42), and in that a quarter (47) of the hinge hook (42) adjacent to the slit (48) is notably blocked off to provide an angular end stop for the rotational movement of the hinge pin (44).

5. Barrier (10) according to claim 1, characterized in that the edges (50, 50A, 50B) of the slit (48) are extended by two guide plates (54) parallel to the plane (P1) of the first frame (18), the ends (56) of which are bent away from one another to make it easier to introduce the hinge pin (44).

6. Barrier (10) according to claim 5, characterized in that the tubular hinge hook (42) is open at its ends and in that a first end (58) of the hinge pin (44) is connected to the edge (26) of the second frame (22) via at least one blade (60), parallel to the plane of the second frame (22) and arranged perpendicularly between the edge (26) of the second frame (22) and the hinge pin, of a thickness smaller than the separation (e) between the edges (50, 50A, 50B) of the slit (48), and which is intended to slide in the slit (48) to allow the hinge pin (44) to be introduced such that it is coaxial with the tubular hinge hook (42).

7. Barrier (10) according to claim 6, characterized in that the first opposite end (58) of the hinge pin (44) is shaped into a point to make it easier to introduce into the hinge hook (42).

8. Barrier (10) according to claim 5, characterized in that the tubular hinge hook (42) is open at its ends and in that at least one stop means (62) is interposed between the hinge pin (44) and the tubular hinge hook (42) to prevent the hinge pin (44) from coming out if one frame is moved along the other.

9. Barrier (10) according to claim 8, characterized in that the stop means comprises a plate (62), perpendicular to the plane of the second frame and arranged perpendicularly between the edge (26) of the second frame (22) and a second end (64) of the hinge pin (44), of a width greater than the separation between the edges (50) of the slit (48), which is intended to come into abutment against the free end (66) of the tubular hinge hook (42) to immobilize the hinge pin (44) axially with respect to the hinge hook.

10. Civil barrier (10) according to claim 1, characterized in that each individual element (12, 13) comprises a single link (12A, 12B) comprising a bottom frame the bottom edge of which has a removable retractable stand (66) at each of its ends.

11. Civil barrier (10) according to claim 1, characterized in that each individual element (12, 13, 14, 15) comprises at least two vertically superposed links (12A, 12B, 13A, 13B, 14A, 14B), and in that a bottom link (12A) comprises a bottom frame (18) the bottom edge of which comprises a removable retractable stand (66) at each of its ends.

12. Civil barrier (10) according to claim 1, characterized in that the first and second frames (18, 22) are bottom and top frames of one and the same link (12A) of one and the same individual element (12), and in that the dismantlable axial hinge means (32) is interposed between horizontal edges (24, 26) of the first and second frames (18, 22).

13. Civil barrier (10) according to claim 12, characterized in that at least one locking means (68) for locking the first and second frames (18, 22) in a coplanar vertical position is interposed between the said first and second frames (18, 22).

14. Civil barrier (10) according to claim 13, characterized in that the first and second frames (18, 22) have the same dimensions and comprise tubular vertical edges (70, 72) which are aligned when the frames (18, 22) are in the coplanar vertical position, and in that the locking means comprises at least one lock bolt (78) which is slidably mounted in one of the vertical edges (70, 72) of one frame (18) and which is able to move between a retracted position in which it is housed in its entirety in the tubular vertical edge (72) of the frame that bears it, and an extended position, in which it can be locked, and in which part of the lock bolt (78) protrudes from the tubular edge (72) of the frame (18) that bears it and is housed in the vertical edge (70) of the other frame (22) in order to prevent the second frame (22) from pivoting on the first frame (18).

15. Civil barrier (10) according to claim 14, characterized in that the tubular edge (72) of the frame (18) slidably housing the lock bolt (78) comprises an oblong slot (80), oriented in the direction of the tubular edge (70, 72) and in which may slide the shank of a screw of which the end is housed in a captive nut secured to the lock bolt (78) and of which a head (86), shaped as a knob, is intended to be tightened onto the tubular edge (70, 72) in order to immobilize the lock bolt (78) in the edge (72) that bears it.

16. Civil barrier (10) according to claim 1, characterized in that the first and second frames (18, 20) are bottom and/or top frames of two horizontally consecutive individual elements (13, 14), and in that the dismantlable axial hinge means is interposed between bottom and/or top vertical edges of the first and second frames (18, 20) of two consecutive individual elements (13, 14).

17. Civil barrier (10) according to claim 1, characterized in that each frame is capable interchangeably at each of the ends of its bottom edge of accepting a removable retractable stand (66) intended to allow it to be used as a bottom frame (18), the said stand (66) being able to move between at least one extended position in which it extends perpendicular to the bottom frame (18) and a retracted position in which it lies such that it is coplanar with the frame (18).

18. Civil barrier (10) according to claim 17, characterized in that each retractable stand comprises a bar (88) which is fixed transversely at the end of a tube (90) mounted such that it can turn in the tubular vertical edge (70, 72) of the associated frame (18), the said bar being vertically immobilized between its extended or retracted end positions or extracted with the tube (90) from the tubular vertical edge (70, 72) by means of a bayonet fitting which comprises:
a disc (92) fixed to the bottom end of the tubular vertical edge (70, 72) and which comprises a radial slit (94),
a bracket (96), of a width smaller than that of the radial slit (94) of the disc (92), which is fixed to the bar (88) and one leg (98) of which extends above a top face (100) of the disc (92),
at least two vertical stops (102, 104) protruding above the top face (100) of the disc in order to determine the two angular rotation positions associated with the extended and retracted positions of the stand, at least one of the stops (102) being removable to allow the bracket (96) to align itself with the slit (94) and to then allow the bar (88) and the tube (90) to be extracted vertically.

19. Civil barrier (10) according to claim 18, characterized in that at least one stop (102) consists of the head of a screw the screw thread of which is housed in the disc (92).

20. Civil barrier (10) according to claim 11, characterized in that each link accepts a connecting means having at least one brace (106) supporting each individual element (12, 13, 14, 15).

21. Civil barrier (10) according to claim 20, characterized in that the brace (106) comprises an inclined tube element (108) a top end (110) of which is connected to the top edge of a top frame of a link (12A), at least an intermediate part (112) of which is connected by a horizontal bar (114) to the junctions between the bottom (18)/top (22) frames of the said link (12A), and a bottom end (116) of which slidably accepts a bar (118) connected to a baseplate (120) for resting on the ground, which baseplate is articulated to the said bar (118) by a pivot (122),
the top end (110) of the brace (106) comprising a horizontal tab (124) intended to straddle the top end of the vertical edge of the top frame (22) of the link (12A) to form the connecting means, and
one end (115) of each horizontal bar (114) connected to each intermediate part (112) comprising a holed tab (126) through which the corresponding lock bolt (78) is intended to pass where the bottom (18) and top (22) frames of a link (12A) meet in order to form the connecting means.

22. Civil barrier (10) according to claim 1, characterized in that each frame (18) accepts a grating (28) or alternatively a set of bars (30) to form the means that fills the said frame.

23. Method of manufacturing a frame (18, 22) of an individual safety barrier element (12) according to claim 1, comprising at least one top horizontal tubular edge (24) and one bottom horizontal edge (25) between which edges a set of bars (30) or gratings (28) extend, characterized in that it comprises:
a first step during which first vertical drillings (132) are made in a bottom wall of the top tubular edge (24) of the frame (18),
a second step during which second vertical drillings (134) are made only in a top wall (136) of the bottom tubular edge (25) of the frame (18), in line with the first drillings (132), and offset third vertical drillings (137) are made in a bottom wall (136) of the bottom tubular edge (25) of the frame (18),
a third step during which a grating (28) or a set of bars (30) of a length substantially corresponding to the vertical distance separating the end faces of the top (24) and bottom (25) edges and the bottom end of which is chamfered at 45 degrees is slipped into the first and second drillings (132, 134) as far as a position of abutment determined by a non-drilled bottom wall (138) of the bottom edge (25),
a fourth step during which the bottom (25) and top (24) edges of the frame (18) and possibly, at discrete points, the grating (28) or the set of bars (30) are connected to an electric arc welding device,
a fifth step during which the frame is immersed in a hot dip galvanizing bath which completes the attachment of all the bars (30) in a single operation, the molten zinc later flowing through the third drillings (137).
